(19) United States
(12) Patent Application Publication
(10) Pub. No.: US 2026/0099662 A1
(43) Pub. Date: Apr. 9, 2026

(54) LIST DETECTION AND STYLIZATION IN DIGITAL CONTENT

(71) Applicant: Adobe Inc., San Jose, CA (US)

(72) Inventors: Sanyam Jain, New Delhi (IN); Shubbham Yadav, Gurgaon (IN); Prateek Gaurav, Lucknow (IN)

(73) Assignee: Adobe Inc., San Jose, CA (US)

(21) Appl. No.: 18/908,034

(22) Filed: Oct. 7, 2024

(51) Int. Cl. G06F 40/103

(52) U.S. Cl. CPC G06F 40/103

(57) ABSTRACT

Automatically detecting and styling lists in textual digital content is described. Digital content that includes unformatted text is processed by a list detection and style system using regular expressions, where each regular expression identifies a list marker pattern. In response to identifying a list marker pattern, the list detection and style system replaces unformatted textual content corresponding to each identified list marker with a marker having a list-style property. Each marker having the list-style property is configured to inherit appearance properties of a list as defined by a digital content template of a style package.

### BACKGROUND

Digital artists often create digital content templates to stylize digital content. Each digital content template includes example digital content displayed according to a particular visual style or theme. The digital template is published for use by others, such as part of a database of digital templates available via a network. Users seeking to stylize their unformatted digital content search the database of digital templates, identify a digital template having a desired visual style or theme, and input their own content into the digital template, such that the user's own content is displayed as having the visual style or theme of the selected digital template. Thus, digital templates are frequently used by a range of users as a tool to create more aesthetically pleasing digital content.

### SUMMARY

Techniques and systems for automatically styling lists in textual digital content is described. In implementations, a computing device receives digital content that includes unformatted text. In some implementations, the digital content received by the computing device has been pre-processed by a machine learning model that is trained to identify different segments in the unformatted text, such as header portions, paragraph portions, and so forth. The computing device employs a list detection and style system to identify one or more portions of the digital content that include a list. To do so, the list detection and style system processes a portion or an entirety of the digital content using regular expressions, where each regular expression identifies a list marker pattern. As a specific example, a list marker pattern identified by a regular expression for a numbered list includes a combination of a numerical value or an alphabetical character and at least one of a punctuation mark or a special character. As another example, a list marker pattern identified by a regular expression for a bulleted list includes a sequence of special characters that each precede textual content, such that each special character in the sequence of special characters denotes a list entry.

In response to identifying a list marker pattern based on the regular expressions, the list detection and style system removes textual content corresponding to each identified list marker (e.g., numbers, letters, special characters, surrounding whitespace, etc.). The removed textual content is then replaced by the list detection and style system with a marker having a list-style property, such that the inserted marker is configured to inherit appearance properties of a list as defined by a style package (e.g., list appearance properties of a digital content template). The list detection and style system is configured to identify and replace list markers is on a per-level basis (e.g., first level, then second level, then third level, etc.) until all markers of a list have been identified and replaced. The resulting formatted list markers are then adaptable to the style of a selected template, such that all markers of a list are updated to adopt the selected template's style, are formatted to react to changes in list entries (e.g., added, removed, or reordered list entries), and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 depicts an environment in an example implementation that is operable to employ digital systems and techniques described herein.

FIG. 2 depicts a system in an example implementation showing operation of a list detection and style system outputting a stylized list in digital content.

FIG. 3 depicts a representation of digital content including at least one list that has been automatically formatted and stylized by a list detection and style system.

FIG. 4 depicts a representation of digital content that includes a formatted list with list markers displayed as inheriting different appearance properties of different style packages.

FIG. 5 depicts a representation of digital content including at least one list that has been automatically formatted and stylized by a list detection and style system.

FIG. 6 is a flow diagram depicting a procedure in an example implementation of generating digital content that includes at least one formatted list.

FIG. 7 is a flow diagram depicting a procedure in an example implementation of replacing list markers in unformatted digital content with formatted list markers.

FIG. 8 illustrates an example system that includes an example computing device that is representative of one or more computing systems and/or devices for implementing the various techniques described herein.

FIG. 8 illustrates an example system that includes an example computing device that is representative of one or more computing systems and/or devices for implementing the various techniques described herein.

### DETAILED DESCRIPTION

### Overview

Generating digital content is a time-consuming and skill-intensive process, which often requires a level of graphic design expertise that many users lack. Given this requisite expertise level, users wanting to create aesthetically pleasing and well-designed digital content are often forced to rely on standard template layouts, such as those provided by widely used word processing applications. In view of this demand for more customized template-based design offerings, design platforms offer a range of templates that provide a variety of different appearance properties to be imparted on a user's digital content.

However, these conventional template-based solutions come with their own set of challenges, as the templates prompt users to replace example digital content (e.g., as input by a template designer to demonstrate the template's appearance properties) with their own digital content. Users frequently encounter difficulties when trying to fit their content into such restrictive templates and, as a result, resort to compromising their digital content by omitting important information to fit a template, adding unnecessary content to fill space, and so forth. Selecting the appropriate template can be challenging, and if a chosen template proves unsuitable during the digital content creation process, users are forced to start over, leading to tedious rework and inhibiting creative options.

As an alternative to forcing users to force their content into restrictive digital templates, some conventional approaches to digital content creation attempt to stylize raw, unformatted text using machine learning classification models. Such conventional machine learning classification analyzes digital content, identifies portions of unformatted text that correspond to different template sections (e.g., headers, sub-headers, paragraph, body, etc.). After identifying a section type using machine learning, these conventional approaches alter a visual appearance of the unformatted text to mimic a digital content template (e.g., displaying header text in a large font size using a first font type and a first color, while displaying body text in a smaller font size using a second font type and a second color).

Although these conventional approaches avoid forcing a user to fit their content into a restrictive template layout, machine learning models are unable to accurately classify certain types of unformatted text, such as lists organized by numbered list markers, lettered list markers, bulleted list markers, and combinations thereof. For example, conventional classification models often fail to accurately identify clear demarcations or clear markings that indicate lists, such as a number followed by an open bracket, a number followed by a dot, a hyphen to indicate a new list entry, and so forth.

To address these conventional shortcomings, automatically styling lists in textual digital content is described. In implementations, a computing device implements a list detection and style system to receive digital content including unformatted text. In some implementations, the digital content that includes unformatted text is received as an output from a conventional machine learning model trained to classify different sections of digital content. The list detection and style system is provided with data describing known patterns that correspond to lists having numbered list markers, lettered list markers, bulleted list markers, or combinations thereof. For each list marker pattern, the list detection and style system generates a complex regular expression. Using the complex regular expressions, the list detection and style system analyzes the unformatted text in the digital content to identify list-level indicators (e.g., a bullet, a dash, an asterisk, a number, a letter, a special character, combinations thereof, and so forth) that serve as markers for individual entries in a list of text.

In response to identifying a list marker, the list detection and style system is configured to replace the list-level indicator from unformatted text with a formatted list marker. In contrast to raw, unformatted text, a correctly formatted list marker ensures that a cohesive style is applied to each entry in the list. For instance, a correctly formatted list marker ensures that each list entry is visually distinguished from other text in the digital content that is not part of the list using a visually identical list marker, such as a bullet point, a number, a letter, and so forth. Furthermore, a correctly formatted list marker imparts cohesive display properties for each entry of the list, such as indentation, line spacing, font properties, and so forth. In further contrast to raw, unformatted text, a correctly formatted list marker ensures that modifications to individual list entries are propagated to all similar entries of the list.

For instance, in the context of a numbered list, a correctly formatted list marker causes renumbering of other list markers when a new entry is added to the list. Similarly, a correctly formatted list marker ensures that uniform indentation, spacing, and so forth is maintained across a hierarchical list level. For instance, in the context of a bulleted list, adjusting an indentation position of a second level bullet in unformatted text does not adjust the indentation position of other second level bullets in the list. Conversely, when properly formatted, adjusting an indentation position of a list marker for the second level bullet enables simultaneous adjustment of the respective indentation positions of other list markers corresponding to the second level bullet in the list. Thus, correctly formatted list markers enable a list to become “live,” such that the list adapts to changes in response to list entry insertions, reordering of list entries, and so forth.

Using formatted list markers (offers several advantages for digital content creators. Firstly, it enhances clarity and organization by allowing information to be easily structured into distinct items, making the content more readable and easier to understand. Additionally, automatic list formatting ensures consistency in the appearance of lists, as management of numbering, bullet points, and indentation for multiple different list markers is achieved with significantly reduced manual intervention, compared to achieving the same visual appearance by manually modifying unformatted text. This not only saves time, but also reduces human error when creating and modifying lists in digital content. Furthermore, editing becomes more efficient by automatically adjusting list markers when entries are added or removed, maintaining a correct sequence and alignment throughout the digital content in which the list is disposed. These advantages make formatted lists in digital content a more effective and user-friendly option compared to an unformatted text representation of the list.

In addition to streamlining the list modification process by eliminating manual steps otherwise required when modifying a list in unformatted text, the formatted list markers generated by the list detection and style system further enable a digital content creator to identify how visual properties of a selected template are imparted on their own content (e.g., without requiring the digital content creator to manually input content into one or more appropriate portions of a conventional digital content template). Similarly, the described formatted list markers enable digital content creators to generate lists in an unformatted matter, thereby eliminating the task of conveying to a computing device which list markers correspond to certain list levels. Via insertion of the formatted list markers into digital content, the list detection and style system is configured to automatically handle list entry formatting, ensuring that lists are displayed cohesively and in a manner that adapts to changes (e.g., entry additions, entry deletions, entry rearrangements, adjustment of an entry's hierarchical level in the list, and so forth). This is an improvement relative to conventional list formatting systems that rely on machine learning models to correctly identify and format list markers, which often leave list marker relics and fail to accurately classify list markers. As a result, an experience of a digital content creator is improved by the described systems, such that the digital content creator is able to impart visual styles of a template on their own digital content in a manner that maintains an intended list structure within the digital content, relative to conventional systems.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

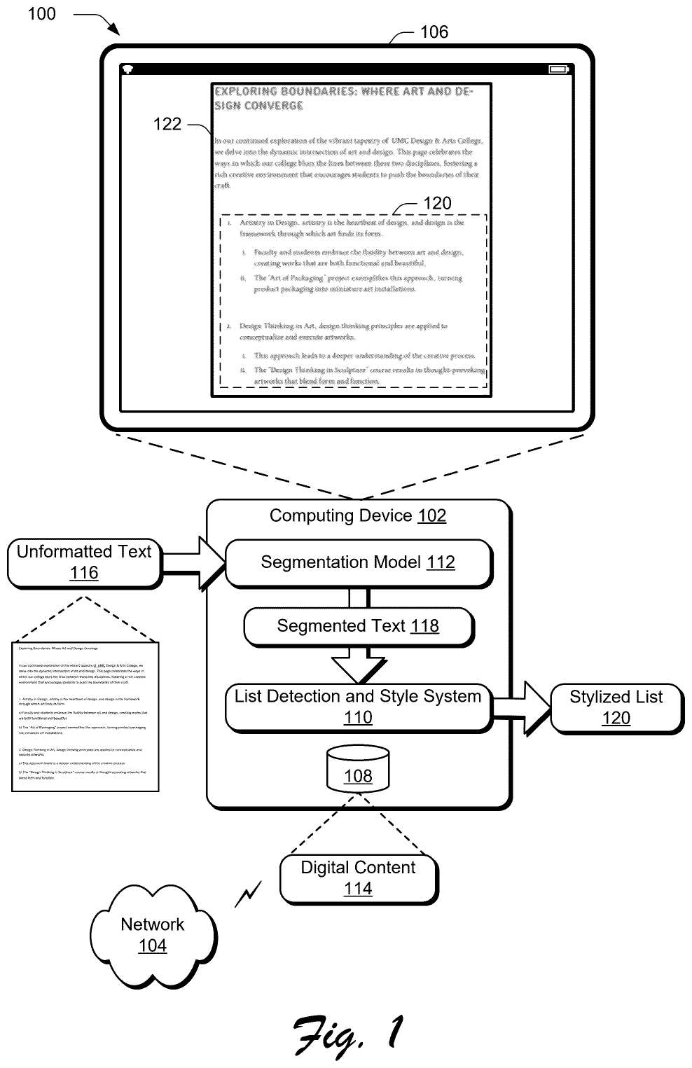

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

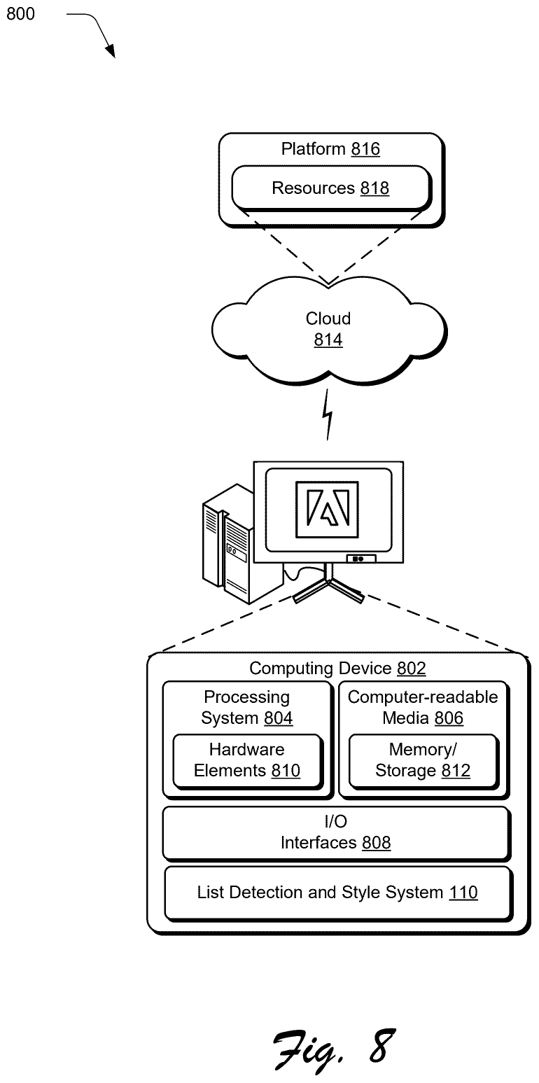

The illustrated environment 100 also includes a display device 106 that is communicatively coupled to the computing device 102 via a wired or a wireless connection. A variety of device configurations are usable to implement the computing device 102 and/or the display device 106, as described in further detail below with respect to FIG. 8. The computing device 102 includes a storage device 108, a list detection and style system 110, and a segmentation model 112. The storage device 108 is configured as storing digital content 114, such as digital images, electronic documents, digital templates, font files of fonts, digital artwork, combinations thereof, and so forth.

In the illustrated example of FIG. 1, the list detection and style system 110 is depicted as receiving unformatted text 116. The unformatted text 116 is representative of textual digital content having at least one list entry that is not associated with special styling or formatting attributes, such as attributes that cause the display device 106 to render text in bold, italics, underlined, a certain font size, a certain color, or as having other visual enhancements. In this manner, the unformatted text 116 is configured to appear in a basic form, such as a form defined by a default font and default font size specified by a word processing application or other digital tool used by a digital content creator to generate the unformatted text 116.

Further, in contrast to formatted text, the unformatted text 116 is representative of textual digital content that excludes one or more embedded Hypertext Markup Language (HTML) tags, markdown syntax, or other code configured to alter an appearance or structure of the unformatted text 116. Thus, in contrast to formatted text, which can include headings, lists, links, and other elements that affect how the content is displayed or interpreted, the unformatted text 116 represents characters (e.g., letters, numbers, symbols, etc.) of textual digital content without additional styling.

In some implementations, the list detection and style system 110 is configured to receive the unformatted text 116 after it has been processed by the segmentation model 112, represented as the segmented text 118 in the illustrated example of FIG. 1. The segmentation model 112 is representative of one or more machine learning models that have been trained to classify and tag different sections of text in the unformatted text 116, such as header sections, body sections, paragraph sections, caption sections, footnote sections, and so forth. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning.

For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data. The segmentation model 112 represents at least one machine learning model trained to receive unformatted text 116 as input and extract relevant features that are useable to identify different sections of text based on content, formatting clues, and the like.

In implementations, the segmentation model 112 generates the segmented text 118 by preprocessing the unformatted text 116 using tokenization, normalization, unnecessary character removal, combinations thereof, and so forth. After preprocessing, the segmentation model 112 extracts features from the unformatted text 116 that help in identifying different sections, using techniques such as deep learning and natural language processing (NLP) to classify portions of the text. Thus, the segmented text 118 is representative of the unformatted text 116, divided into structured sections that are labeled according to their roles within the digital content 114. Although depicted in the illustrated example of FIG. 1 as being implemented by the computing device 102, in some implementations the segmentation model 112 is employed by a different computing device, such as another computing device communicatively coupled to the computing device 102 via the network 104.

The list detection and style system 110 is configured to output at least one stylized list 120 for the unformatted text 116 or the segmented text 118. As described in further detail below, in implementations where the list detection and style system 110 receives the unformatted text 116 without processing by the segmentation model 112, the list detection and style system 110 analyzes an entirety of the unformatted text 116 to identify one or more portions that include list and replace the one or more portions with a corresponding stylized list 120. Alternatively, in implementations where the list detection and style system 110 receives the segmented text 118 (e.g., receives the unformatted text 116 after it has been processed by the segmentation model 112), the list detection and style system 110 analyzes only a portion of the segmented text 118, such as sections that are likely to include lists (e.g., paragraph sections, body sections, etc.) while disregarding analysis of sections that are unlikely to include lists (e.g., headers, footnotes, etc.).

The list detection and style system 110 is configured to analyze the unformatted text 116, or one or more portions of the segmented text 118, using complex regular expressions that each correspond to a pattern indicating presence of list markers in digital content 114, as described in further detail below. In response to identifying one or more lists in the unformatted text 116, the list detection and style system 110 is configured to remove existing, unformatted list markers from the unformatted text 116 and replace the unformatted list markers with markers that each have a list-style property. In some implementations, the list detection and style system 110 identifies and replaces list markers on a per-level basis (e.g., by first identifying and replacing first level or “top-level” list markers, then second level list markers indicating a subcategory of a top-level list marker, then third level list markers, and so forth). The list detection and style system 110 is configured to identify and replace each list marker in the unformatted text 116 to generate a stylized list 120 for each list included in the unformatted text 116. The resulting stylized list 120 can then be adapted in its entirety to the style of a selected template (e.g., all markers of a list are updated to adopt the selected template's style).

For instance, in the illustrated example of FIG. 1, the stylized list 120 is depicted as being rendered by the display device 106 as part of formatted digital content 122. In contrast to its visual representation in the unformatted text 116, the stylized list 120 as included in the formatted digital content 122 is configured by the list detection and style system 110 as having the visual properties of a digital template, such as a template selected by a user of the computing device 102. As an example, list markers for the stylized list 120 are displayed in a cohesive style, with uniform spacing and indentation across different list entries of a same level. In contrast to the visually unpleasing appearance of unformatted text 116, the stylized list 120 included in the formatted digital content 122 is aesthetically pleasing as a result of inheriting the appearance properties of a digital content template.

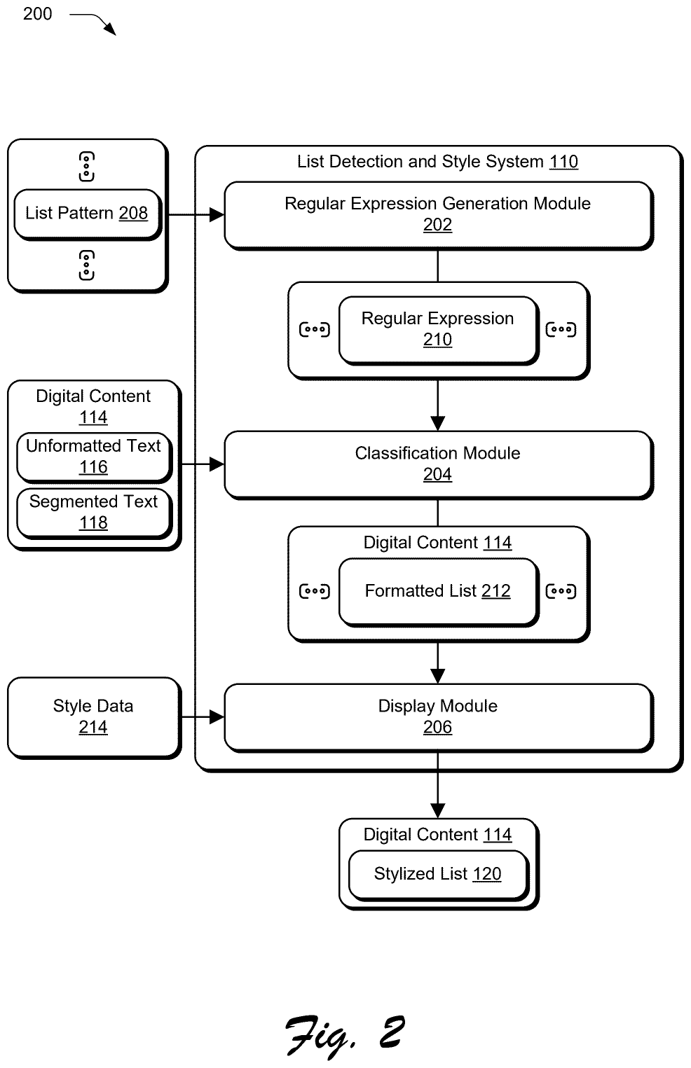

FIG. 2 depicts a system 200 in an example implementation showing operation of the list detection and style system 110 outputting a stylized list 120 in digital content 114. To do so, the list detection and style system 110 includes a regular expression generation module 202, a classification module 204, and a display module 206. The regular expression generation module 202 receives at least one list pattern 208. The list pattern 208 is representative of data describing the visual appearance of list markers that each identify an entry in a list.

List pattern 208 is representative of various numbering and bullet styles, tailored to different hierarchical levels within a list. For instance, in an example implementation the list pattern 208 includes data describing a numbering pattern defined by a numerical value in combination with at least one punctuation mark or special character, such as “1.” or “1)”. As another example, the list pattern 208 includes data describing alphabetic characters alongside punctuation marks or special characters, such as “A.” or “a)”. Examples of punctuation marks and special characters described by a list pattern 208 include quotes (”), brackets (( )), braces ({ }), square brackets ([ ]), angle brackets (< >), hashes (#), hyphens (-), dots (.), colons (:), semi-colons (;), underscores (_), tildes (˜), and other symbols.

In addition to numbered list patterns (e.g., list markers that include numerical and/or alphabetical characters), the list pattern 208 is representative of data describing list markers for bulleted lists. As examples, list markers for bulleted lists include symbols such as arrows (→), bullet points (•), hyphens (-), hashes (#), currency signs ($), percentage signs (%), and other special characters, each serving to visually distinguish list entries from one another.

In implementations, each list pattern 208 specifies a first-level list marker pattern, and optionally sub-level list marker patterns. In implementations where a list pattern 208 defines subsequent level patterns, the list pattern 208 is representative of data describing hierarchical relationships within a list, providing a visual structure that clearly indicates position(s) of sub-level entries relative to first level list entries. For example, a first-level item might be marked with “1.”, while a second-level item under it could be marked with “1.1” or “(a)”. This hierarchical patterning ensures that the organization of the list is clear and easily interpretable, even when multiple levels of indentation or nesting are involved in a given list pattern 208.

For each list pattern 208, the regular expression generation module 202 is configured to generate a regular expression 210. A regular expression 210, which may also be referred to as a rational expression, represents a sequence of characters that specifies a match pattern in textual digital content, which is useable by the classification module 204 to perform “find and replace” operations on textual content included in the unformatted text 116. As a specific example, consider a scenario where the regular expression generation module 202 generates the regular expression 210 for a list pattern 208, as set forth in Expression 1:

$$( \hat{} ∖ s * ( [ - \cdot * o ] \vert ∖ d + ∖ . \vert ∖ d + ∖ ) \vert ∖ w ∖ ) \vert ∖ w ∖ . ) ∖ s + . * \$ + . \qquad ( Expression 1 )$$

In Expression 1, the carat “A” asserts the position at the start of a line. By asserting the position at the start of a line, the regular expression generation module 202 ensures that the regular expression 210 identifies list markers as occurring at the start of a line in unformatted text 116, which is crucial for detecting list entries that start as new lines in unformatted text 116. In Expression 1, the “\s*” element accounts for whitespace (e.g., spaces or tabs in unformatted text 116), and causes the classification module 204 to identify list markers that are not preceded by whitespace as well as list markers having preceding whitespace in the unformatted text 116. The grouping of elements “([-•*o]/\d+\./\d+\)/\w\)/\wl.)” in Expression 1 generally represents elements of the regular expression 210 that match different list markers.

For instance, the element “[-•*o]” causes the regular expression 210 to match common bullet symbols such as hyphens, bullets asterisks, and small circles. The element “\d+\.” causes the regular expression 210 to match one or more digits (e.g., numerical characters) followed by a period, thus covering numbered lists having list markers of “1., 2., 3 . . . ”. The element “\d+\)” causes the regular expression 210 to match one or more digits followed by a closing parenthesis, thus covering numbered lists having list markers “1), 2), 3) . . . ”. The element “\w\)” causes the regular expression 210 to match a letter (e.g., an alphabetical character) followed by a closing parenthesis, thus covering numbered lists having list markers of “a), b), c) . . . ”. The element “\w\.” causes the regular expression 210 to match one or more letters followed by a period, thus covering numbered lists having list markers of “a., b., c. . . . ”.

In Expression 1, the element “\s+” matches one or more whitespace characters following a list marker, thus ensuring that the regular expression 210 accounts for whitespace disposed between a list marker and characters corresponding to text of a list entry. In this manner, the regular expression 210 is configured to account for whitespace disposed adjacent to list markers in unformatted text 116. The element “.*” is optionally included in the regular expression 210 and represents functionality of the regular expression 210 to identify textual content corresponding to a list entry identified by a list marker (e.g., to distinguish a list entry from a list marker). Finally, the element “$” asserts the position at the end of a line, thereby ensuring that a list entry match identified by the regular expression 210 extends to the end of a list entry in the unformatted text 116. The regular expression 210 is further generated to include a quantifier “+”, which applies to the entire preceding grouped pattern, thus causing the regular expression 210 to match multiple instances of a list marker in the list pattern 208, which enables the classification module 204 to capture multiple list entries that appear consecutively in the unformatted text 116.

Although described in context of the specific regular expression 210 set forth in Expression 1, the list detection and style system 110 is configured to generate regular expressions 210 in a range of different manners, depending on a computing environment in which the list detection and style system 110 is disposed, a programming language being used by a computing device 102 implementing the list detection and style system 110, and so forth. In some implementations, the regular expression 210 is generated to only match list markers having consecutive list entries. Alternatively, in some implementations the regular expression 210 is generated to match a single list marker, such as a single bullet point that separates text in the digital content 114 from surrounding text.

Given the regular expression 210, the classification module 204 processes digital content 114 (e.g., the unformatted text 116 or one or more portions of the segmented text 118) to generate a formatted list 212. To do so, the classification module 204 is configured to delete, from the digital content 114, characters that match the regular expression 210 as being a list marker that identifies a list entry, as well as whitespace corresponding to the identified list marker. The classification module 204 then replaces each identified list marker with a formatted list marker having the same characters (e.g., numbers, letters, bullet points, special characters, symbols, or combinations thereof) that is configured to inherit appearance properties of a style package (e.g., of a digital template included in a style package).

The digital content 114 having the formatted list 212, in place of an unformatted list included in the unformatted text 116 or the segmented text 118, is then provided to the display module 206. The display module 206 represents functionality of the list detection and style system 110 to render the formatted list 212 as a stylized list 120 that includes appearance properties of style data 214 (e.g., visual attributes of a style package defined by a digital template selected by a user of the list detection and style system 110, automatically selected by the list detection and style system 110, or combinations thereof). The display module 206, for instance, renders the stylized list 120 in digital content 114 as having visual characteristics of the style data 214 via the display device 106. In this manner, the list detection and style system 110 enables a digital content creator to readily perceive how different style packages, such as visual attributes defined by one or more digital templates, will appear when imparted on lists included in the digital content 114. Advantageously, the list detection and style system 110 does so without requiring the digital content creator to manually annotate or otherwise distinguish list markers from other characters in the digital content 114.

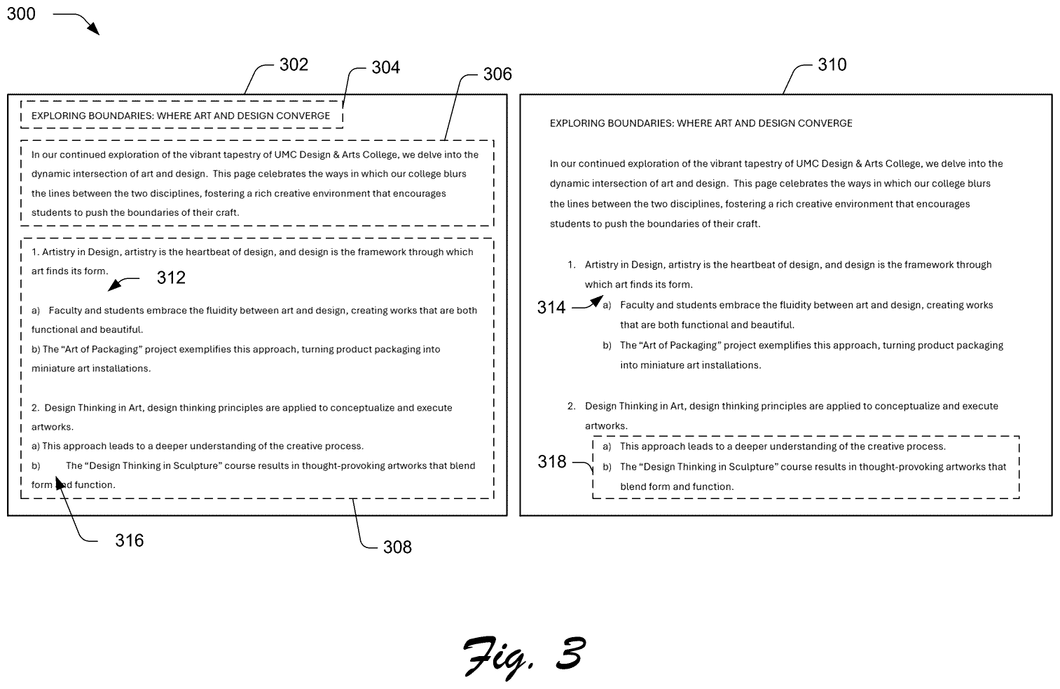

FIG. 3 depicts a representation 300 of digital content including at least one list that has been automatically formatted and stylized by the list detection and style system 110. In the illustrated example of FIG. 3, digital content 302 represents an example instance of unformatted text 116 or segmented text 118. For instance, digital content 302 includes textual content generally segmented into a header section 304, a body section 306, and a body section 308. The body section 308 includes an unformatted list having unformatted list markers and inconsistent formatting across similar hierarchical levels of the list.

Digital content 310 represents an example instance of the digital content 114 as having a formatted list 212, contrasted with the unformatted list of body section 308. The digital content 310 is generated by the list detection and style system 110 using regular expressions and independent of one or more machine learning models, by replacing unformatted list markers and their associated whitespace with formatted list markers. For instance, the formatted list 212 of digital content 310 deletes the whitespace 312 separating a first-level list marker from a second-level list marker such that uniform spacing 314 is achieved for all instances of first-level list markers followed by second-level list markers in the digital content 114.

The formatted list 212 of digital content 310 further eliminates the inconsistent indentation of the unformatted text included in the body section 308. For instance, indentation 316 represents an indentation for a second-level list marker that differs from other second-level list markers in the unformatted text of body section 308. Conversely, portion 318 in digital content 310 depicts how the formatted list 212 is generated to display same-level list markers as having a uniform indentation that visually distinguishes the list level from other list levels (e.g., second-level list markers are indented further from a line start than first-level list markers).

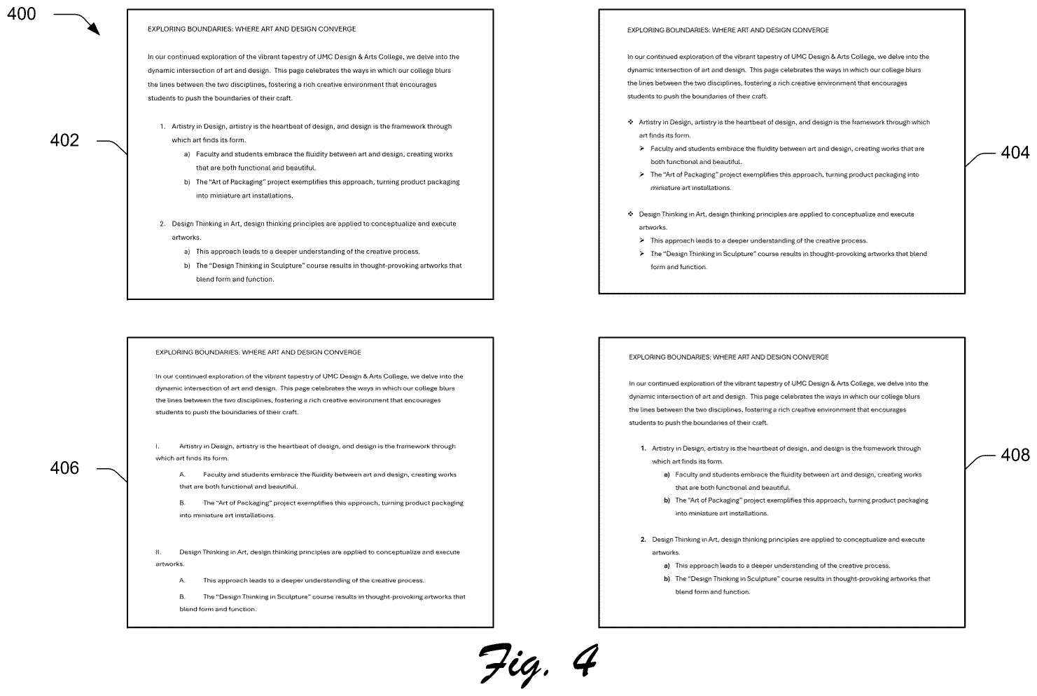

FIG. 4 depicts a representation 400 of digital content that includes a formatted list, where list markers of the formatted list are displayed as inheriting different appearance properties of different style packages. For instance, in the illustrated example of FIG. 4, digital content 402 depicts an instance where a formatted list 212 includes numerical first-level list markers (e.g., “1.” and “2.”) and alphabetical second-level list markers (e.g., “a)” and “b)”). Digital content 404 depicts an instance where the formatted list 212 includes diamond symbol first-level list markers and arrow symbol second-level list markers. Digital content 406 depicts an instance where the formatted list 212 includes roman numeral first-level list markers (e.g., “I.” and “II.”) and alphabetical second-level list markers (e.g., “A.” and “B.”). Digital content 408 depicts an instance where the formatted list 212 includes bolded numerical first-level list markers (e.g., “1.” and “2.”) and bolded alphabetical second-level list markers (e.g., “a)” and “b)”).

In this manner, the digital content 402, the digital content 404, the digital content 406, and the digital content 408 each represent a different instance of the stylized list 120 as output by the display module 206 by applying respective different style data 214 to the digital content 114. Advantageously, the digital content 402, the digital content 404, the digital content 406, and the digital content 408 are each output by the display module 206 by modifying only the formatted list markers to inherit visual properties of the style data 214 and without modifying textual content of a list entry corresponding to each list marker. The list detection and style system 110 thus enables a digital content creator to conveniently preview how different style packages or digital templates, having associated style data 214, will appear when applied to the digital content creator's unformatted text 116.

As a further advantage to unformatted text 116, the formatted list 212 generated by the list detection and style system 110 includes “live” list markers, which are configured to adapt to changes in list entries, such as list entry additions, list entry deletions, list entry rearrangements, and combinations thereof.

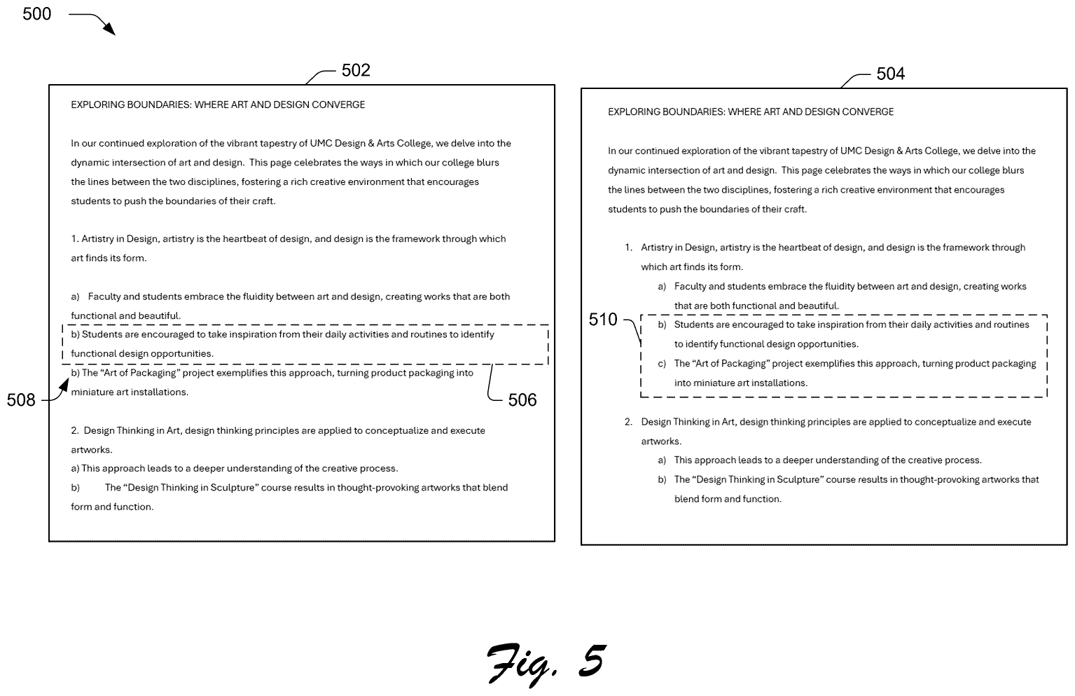

FIG. 5 depicts a representation 500 of digital content including at least one list that has been automatically formatted and stylized by the list detection and style system 110. In the illustrated example of FIG. 5, digital content 502 represents an instance of unformatted text 116 and digital content 504 represents an instance of formatted digital content 122. The digital content 502 represents an example implementation where a digital content creator adds list entry 506 to a list, such as inserted before a list entry identified by list marker 508.

In the illustrated example of FIG. 5, the list entry 506 is intended to be identified by a second-level list marker “b)”, which follows an initial second-level list marker “a)”. However, due to being inserted in unformatted text, insertion of the list entry 506 results in redundant “b)” list markers, which forces a digital content creator to manually change list marker 508 (e.g., to “c)”) in order for the digital content 502 to include a coherent list.

Conversely, because digital content 504 includes formatted list markers as inserted by the list detection and style system 110, insertion of the list entry 506 causes automatic updating of other list markers in the list, as indicated by portion 510. In this manner, the formatted digital content 122 generated by the list detection and style system 110 not only includes a stylized list 120 configured to inherit visual properties of a designated style package, but also enables modification to list entries in a manner that preserves a coherency of the list. These advantages provided by the list detection and style system 110 in generating formatted digital content 122 are not realized by conventional systems that rely on machine learning models to accurately classify lists in textual digital content.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5.

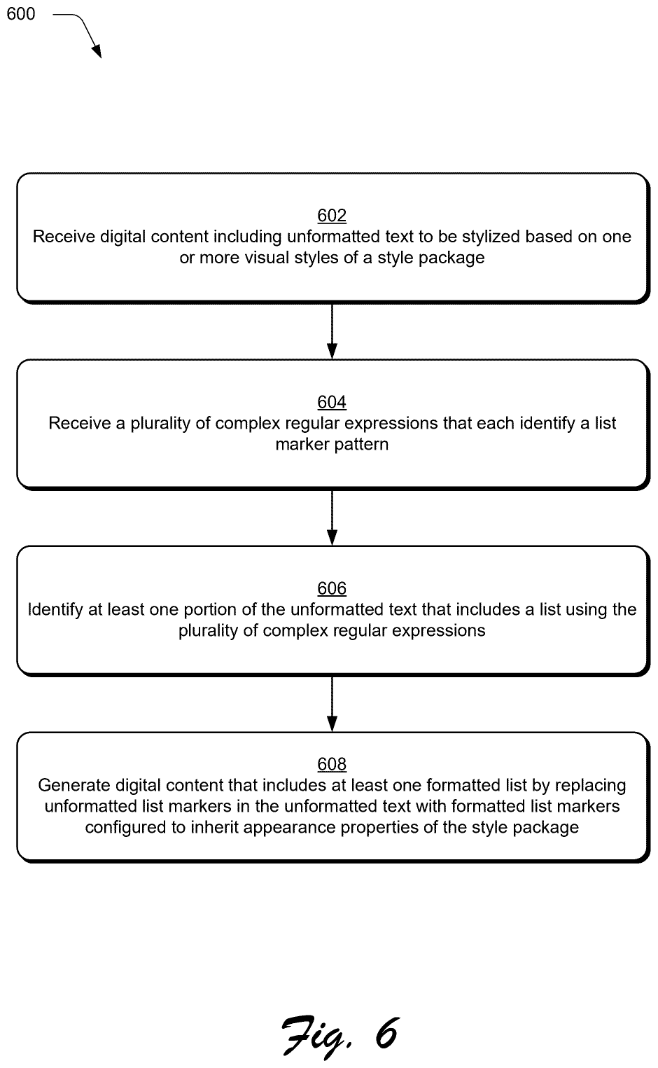

FIG. 6 is a flow diagram depicting a procedure 600 in an example implementation of generating digital content that includes at least one formatted list. To begin, digital content including unformatted text to be stylized based on one or more visual styles of a style package is received (block 602). The list detection and style system 110, for instance, receives unformatted text 116 or receives segmented text 118.

A plurality of complex regular expressions that each identify a list marker pattern are then received (block 604). The regular expression generation module 202, for instance, generates a regular expression 210 for each list pattern 208 provided to the list detection and style system 110. At least one portion of the unformatted text that includes a list is then identified using the plurality of complex regular expressions (block 606). The classification module 204, for instance, searches the unformatted text 116 or a portion of the segmented text 118 using the regular expression 210 to identify characters in the digital content 114 that match list markers specified by the regular expression 210.

Digital content that includes at least one formatted list is then generated by replacing unformatted list markers in the unformatted text with formatted list markers that are configured to inherit appearance properties of the style package (block 608). The classification module 204, for instance, deletes characters from the unformatted text 116 or the segmented text 118 in the digital content 114 that match list markers identified by the regular expression 210 and replace the deleted characters with formatted list markers that are configured to inherit visual properties of style data 214 for a digital template included in a style package.

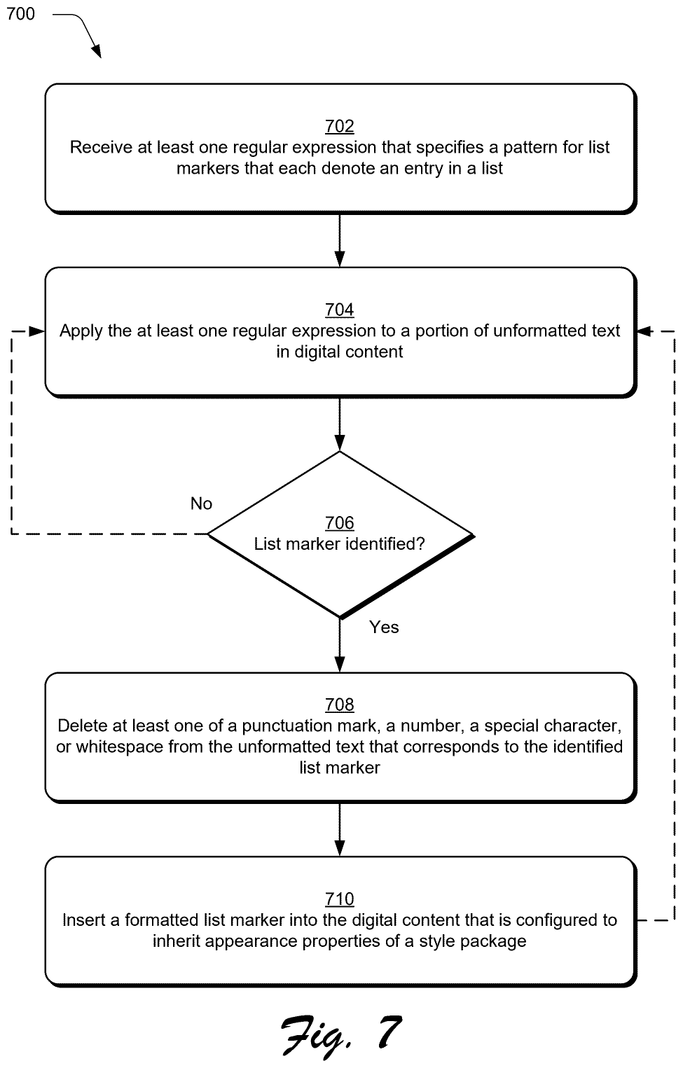

FIG. 7 is a flow diagram depicting a procedure 700 in an example implementation of replacing list markers in unformatted digital content with formatted list markers. To begin, at least one regular expression that specifies a pattern for list markers that each denote an entry in a list is received (block 702). The regular expression generation module 202, for instance, generates a regular expression 210 for each list pattern 208 provided to the list detection and style system 110.

The at least one regular expression is then applied to a portion of unformatted text in digital content (block 704). The classification module 204, for instance, searches the unformatted text 116 or a portion of the segmented text 118 using the regular expression 210 to identify characters in the digital content 114 that match list markers specified by the regular expression 210.

As part of applying the at least one regular expression to the unformatted text, a determination is made as to whether a list marker is identified by the regular expression (block 706). If no list marker is identified (e.g., a “No” determination at block 706), operation of the procedure 700 returns to block 704 to analyze the unformatted text using the at least one regular expression (e.g., analyze a remainder of the unformatted text using a same regular expression, analyze the unformatted text using a different regular expression, or combinations thereof).

Alternatively, in response to identifying a list marker (e.g., a “Yes” determination at block 706), at least one of a punctuation mark, a number, a special character, or whitespace that corresponds to the identified list marker is deleted from the unformatted text (block 708). The classification module 204, for instance, deletes from the digital content 114 one or more characters that match a list marker identified by a regular expression 210.

A formatted list marker that is configured to inherit appearance properties of a style package is then inserted into the digital content (block 710). The classification module 204, for instance, inserts a formatted list marker into a position of the digital content 114 that corresponds to a position from which one or more characters were deleted from the unformatted text 116 at block 708. Operation then optionally returns to identify other list markers in the unformatted text 116, as indicated by the dashed arrow returning to block 704 from block 710 (e.g., until an entirety of the unformatted text 116 has been processed by the list detection and style system 110), such that all unformatted list markers in unformatted text 116 are replaced by formatted list markers.

### Example System and Device

FIG. 8 illustrates an example system 800 that includes an example computing device that is representative of one or more computing systems and/or devices that are usable to implement the various techniques described herein. This is illustrated through inclusion of the list detection and style system 110. The computing device 802 includes, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that are configured as processors, functional blocks, and so forth. This includes example implementations in hardware as an application specific integrated circuit or other logic device formed using one or more semiconductors. The hardware elements 810 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 806 is illustrated as including memory/storage 812. The memory/storage 812 represents memory/storage capacity associated with one or more computer-readable media. In one example, the memory/storage 812 includes volatile media (such as random access memory (RAM)) and/or nonvolatile media (such as read only memory (ROM), Flash memory, optical disks, magnetic disks, and so forth). In another example, the memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 810. For example, the computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supportable by various configurations of the computing device 802 and are not limited to the specific examples of the techniques described herein. This functionality is also implementable entirely or partially through use of a distributed system, such as over a “cloud” 814 as described below.

The cloud 814 includes and/or is representative of a platform 816 for resources 818. The platform 816 abstracts underlying functionality of hardware (e.g., servers) and software resources of the cloud 814. For example, the resources 818 include applications and/or data that are utilized while computer processing is executed on servers that are remote from the computing device 802. In some examples, the resources 818 also include services provided over the Internet and/or through a subscriber network, such as a cellular or Wi-Fi network.

The platform 816 abstracts the resources 818 and functions to connect the computing device 802 with other computing devices. In some examples, the platform 816 also serves to abstract scaling of resources to provide a corresponding level of scale to encountered demand for the resources that are implemented via the platform. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

What is claimed is:

1. A method comprising:
receiving, by a processing device, textual digital content to be stylized based on one or more visual styles of a style package that defines appearance properties for the textual digital content;
generating, by the processing device, a plurality of complex regular expressions that each identify a list marker pattern;
identifying, by the processing device, at least one portion of the textual digital content that includes a list using the plurality of complex regular expressions; and
modifying, by the processing device, the textual digital content by replacing unformatted list markers in the at least one portion of the textual digital content with formatted list markers configured to inherit appearance properties of the style package.

2. The method of claim 1, wherein the list marker pattern of one of the plurality of complex regular expressions comprises a first level numbering pattern defined by a numerical value and at least one of a punctuation mark or a special character.

3. The method of claim 2, wherein the list marker pattern of the one of the plurality of complex expressions defines at least one subsequent level numbering pattern that specifies a hierarchical position of the at least one subsequent level numbering pattern relative to the first level numbering pattern.

4. The method of claim 2, wherein the list marker pattern of the one of the plurality of complex regular expressions considers whitespace disposed adjacent to one or more of the numerical value or the at least one of the punctuation mark or the special character.

5. The method of claim 1, wherein the list marker pattern of one of the plurality of complex regular expressions comprises a first level numbering pattern defined by an alphabetic character and at least one of a punctuation mark or a special character.

6. The method of claim 1, wherein the received textual digital content is segmented into at least one heading portion and at least one body portion, wherein identifying the at least one portion of the textual digital content that includes the list comprises applying the plurality of complex regular expressions to the at least one body portion without applying the plurality of complex regular expressions to the at least one heading portion.

7. The method of claim 1, further comprising:
receiving, by the processing device, a selection of one of the one or more visual styles of the style package; and
applying appearance properties of the selected one of the one or more visual styles to the formatted list markers in the textual digital content.

8. The method of claim 1, wherein identifying the at least one portion of the textual digital content that includes the list using the plurality of complex regular expressions is performed independent of processing the textual digital content using a machine learning model.

9. A system comprising:
a memory component; and
a processing device coupled to the memory component, the processing device to perform operations comprising:
receiving textual digital content to be stylized based on one or more visual styles of a style package that defines appearance properties for the textual digital content;
generating a plurality of complex regular expressions that each identify a list marker pattern;
identifying at least one portion of the textual digital content that includes a list using the plurality of complex regular expressions; and
modifying the textual digital content by replacing unformatted list markers in the at least one portion of the textual digital content with formatted list markers configured to inherit appearance properties of the style package.

10. The system of claim 9, wherein the list marker pattern of one of the plurality of complex regular expressions comprises a first level numbering pattern defined by a numerical value and at least one of a punctuation mark or a special character.

11. The system of claim 10, wherein the list marker pattern of the one of the plurality of complex expressions defines at least one subsequent level numbering pattern that specifies a hierarchical position of the at least one subsequent level numbering pattern relative to the first level numbering pattern.

12. The system of claim 10, wherein the list marker pattern of the one of the plurality of complex regular expressions considers whitespace disposed adjacent to one or more of the numerical value or the at least one of the punctuation mark or the special character.

13. The system of claim 9, wherein the list marker pattern of one of the plurality of complex regular expressions comprises a first level numbering pattern defined by an alphabetic character and at least one of a punctuation mark or a special character.

14. The system of claim 9, wherein the received textual digital content is segmented into at least one heading portion and at least one body portion, wherein identifying the at least one portion of the textual digital content that includes the list comprises applying the plurality of complex regular expressions to the at least one body portion without applying the plurality of complex regular expressions to the at least one heading portion.

15. The system of claim 9, the operations further comprising:
receiving a selection of one of the one or more visual styles of the style package; and
applying appearance properties of the selected one of the one or more visual styles to the formatted list markers in the textual digital content.

16. A non-transitory computer-readable storage medium storing executable instructions, which when executed by a processing device, cause the processing device to perform operations comprising:
receiving textual digital content to be stylized based on one or more visual styles of a style package that defines appearance properties for the textual digital content;
generating a plurality of complex regular expressions that each identify a list marker pattern;
identifying at least one portion of the textual digital content that includes a list using the plurality of complex regular expressions; and
modifying the textual digital content by replacing unformatted list markers in the at least one portion of the textual digital content with formatted list markers configured to inherit appearance properties of the style package.

17. The non-transitory computer-readable storage medium of claim 16, wherein the list marker pattern of one of the plurality of complex regular expressions comprises a first level numbering pattern defined by a numerical value and at least one of a punctuation mark or a special character.

18. The non-transitory computer-readable storage medium of claim 16, wherein the list marker pattern of one of the plurality of complex regular expressions comprises a first level numbering pattern defined by an alphabetic character and at least one of a punctuation mark or a special character.

19. The non-transitory computer-readable storage medium of claim 16, wherein the received textual digital content is segmented into at least one heading portion and at least one body portion, wherein identifying the at least one portion of the textual digital content that includes the list comprises applying the plurality of complex regular expressions to the at least one body portion without applying the plurality of complex regular expressions to the at least one heading portion.

20. The non-transitory computer-readable storage medium of claim 16, the operations further comprising:
receiving a selection of one of the one or more visual styles of the style package; and
applying appearance properties of the selected one of the one or more visual styles to the formatted list markers in the textual digital content.
